(19) United States
(12) Patent Application Publication
(10) Pub. No.: US 2009/0199290 A1
(43) Pub. Date: Aug. 6, 2009

(54) VIRTUAL PRIVATE NETWORK SYSTEM AND METHOD

(75) Inventors: David McCullough, Upper Brookfield (AU); Tom Essebier, Chapel Hill (AU); Philip Craig, Annerley (AU)

Correspondence Address: SCHWEGMAN, LUNDBERG & WOESSNER, P.A., P.O. BOX 2938, MINNEAPOLIS, MN, 55402, US

(73) Assignee: Secure Computing Corporation, San Jose, CA (US)

(21) Appl. No.: 12/049,703

(22) Filed: Mar. 17, 2008

Related U.S. Application Data
(60) Provisional application No. 61/025,532, filed on Feb. 1, 2008.

(51) Int. Cl. G06F 17/00

(52) U.S. Cl. 726/12

(57) ABSTRACT

One embodiment of the application provides a method and system for receiving at a gateway device a plurality of virtual private network tunnels to be routed to a Local Area Network (LAN), routing a first portion of the plurality of virtual private network tunnels to at least one slave device coupled to the gateway device, performing IPsec processing of the first portion of the plurality of virtual private network tunnels using at least one slave device, forwarding the first portion of the plurality of virtual private network tunnels after IPsec processing to at the gateway device and routing the plurality of virtual private network tunnels to the LAN.

### RELATED APPLICATIONS

This application claims the priority benefit of U.S. Provisional Application Ser. No. 61/025,532 filed Feb. 1, 2008, the contents of which are incorporated herein by reference in their entirety.

### BACKGROUND OF THE INVENTION

1. Field of the Invention

The present invention is related to computer network security, and more particularly, to a virtual private network system and method.

2. Description of the Related Art

As both personal and business use of the Internet has grown, a need for secure and confidential transmission over the Internet has also dramatically increased. Users frequently require assurance that the party sending and/or receiving a transmission is in fact the intended party, and that no other party can intercept (and understand and/or alter) the transmission during the transmission process. Companies or other entities use Virtual Private Network (VPN) connections which enable two or more locations to communicate securely and effectively, usually across a public network such as the internet.

VPN provides key traits namely privacy, authentication, and integrity. Using VPN, one can access an office network securely across the internet. On a business trip, one can connect to an Internet access service provider (ISP) and then create a second connection (called a “tunnel”) into an office network across the Internet and have similar access to the corporate network as if connected directly from the office. Similarly, telecommuters can also set up a VPN tunnel over their dialup modem, cable modem or DSL links to their local ISP to access their corporate network. VPN tunnels can be configured using either Point-to-Point Tunneling Protocol (PPTP), Internet Protocol Security (IPsec), or Layer 2 Tunneling Protocol (L2TP). IPsec is a widely used form of VPN. IPsec is typically implemented in a client-gateway or gateway-gateway application.

A firewall prevents network intrusion during the transfer of traffic between computer networks of different trust levels. In general, a firewall is a boundary between one computer (or, more frequently, a network of computers) and other computers. Thus information behind the firewall is protected from viewing by an authorized party that is outside of the firewall. A primary technique used for countering eavesdropping (i.e., for providing encryption/decryption) includes using the IP Security protocols (IPsec). IPsec is implemented in a firewall, so that all traffic passing through is subject to encryption. Additionally, IPsec is implemented at the network layer of the protocol stack, and does not interfere with the behavior of application protocols. IPsec is transparent to individual users and use their authentication mechanisms to detect unauthorized traffic and traffic whose contents have been modified in transit. All data that fails the authentication tests are discarded. For this to work, each pair of IPsec endpoints must be able to establish and verify each other's identity.

Typically, IPsec provides enterprise-grade security, and is generally used for connecting two or more networks, such as a branch office to a head office. IPsec provides either transport mode (end-to-end) security of packet traffic in which the end-point computers do the security processing, or tunnel mode (portal-to-portal) communications security in which security of packet traffic is provided to several machines (even to whole LANs) by a single node.

In IPsec, a relationship is established for a tunnel between the endpoints. The relationship rules are documented in a security association (SA), which describes a one-way connection that defines, for example, encryption algorithms and keys to be used during information exchange. Although two endpoints may establish their mutual connection manually, most IPsec products negotiate them automatically using the Internet Key Exchange (IKE) protocol. In one approach, SAs are defined by a security parameter index (SPI), an IP destination address and a security protocol identifier (the two primary security protocols being the well-known authentication header (AH) and encapsulating security payload (ESP) protocols). The SPI is an identification tag added to the header while using IPsec for tunneling the IP traffic. This tag helps the kernel discern between two traffic streams where different encryption rules and algorithms may be in use. ESP works between hosts, between a host and a security gateway, or between security gateways. The support for security gateways (in Tunnel-mode) permits trustworthy networks behind a security gateway to omit encryption while using security gateways to obtain confidentiality for transmissions over untrustworthy network segments. In tunnel-mode ESP encapsulates the entire IP datagram within the ESP.

A gateway device typically is capable of supporting a limited number of IPsec VPN tunnels. Configuring additional IPsec VPN tunnels in the gateway device above an optimum number of IPsec VPN tunnels can result in instability of the existing tunnels or may require unnecessary tunnel restarts. In some cases, the gateway simply fails to complete startup and operation of all tunnels in a timely and reliable manner. This occurs due to the lack of resources in the Central Processing Unit (CPU) and the memory within the gateway device. What is needed is a system and method for increasing the IPsec VPN tunnels that can be added to a given gateway beyond the capacity of that gateway device.

### BRIEF DESCRIPTION OF THE DRAWINGS

FIG. 1 illustrates a system showing a firewall device that provides virtual private network (VPN) connections and accommodates additional IPsec tunnels using offload devices, according to some embodiments of the invention.

FIG. 2 illustrates the system shown in FIG. 1 having a multi-port switch used to couple the offload devices to the firewall device, according to some embodiments of the invention.

FIG. 3 illustrates the system shown in FIG. 1 having the offload devices coupled to the firewall device in a daisy-chain configuration, according to some embodiments of the invention.

FIG. 4 illustrates a method to add IPsec tunnels to a firewall device using offload devices, according to some embodiments of the invention.

FIG. 5 illustrates a network diagram showing a system and method for off-loading VPN tunnels from a master device onto a slave device, according to some embodiments of the invention.

FIG. 6 is a block diagram illustrating a master device in the example form of a computer system, within which a set of sequence of instructions for causing the master device to perform any one of the methodologies discussed herein may be executed.

### DETAILED DESCRIPTION OF THE INVENTION

In the following detailed description of the preferred embodiments, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

In connecting a larger (such as, central or head-office) site to many smaller (branch-office) sites via Virtual Private Network interfaces (IPsec VPN), the resources (such as CPU, RAM, throughput, maximum tunnels) of the VPN gateway device at the larger site can quickly be exhausted. Often when a given VPN gateway device is configured to support a large number of IPsec tunnels, the VPN gateway device might not have the processing capability in its CPU or memory resources to continue the addition of more IPsec tunnels to the existing configuration. In some embodiments, the cryptographic key exchanges and VPN management overheads with the large number of tunnels prevent the device from completing the startup and operation of all tunnels in a timely and reliable manner. As the startup and re-keying of tunnels is quite expensive, it can consume the resources needed to keep running tunnels stable, thereby resulting in many more tunnels needing to be restarted. This can cause a snowball effect and needlessly bring large numbers of tunnels down.

It would be nice to be able to add additional VPN processing capabilities to the VPN Gateway, without having to replace existing infrastructure, needing to configure additional Internet IP addresses, create complex failover configuration or have to use multiple independent user interfaces. That is without disrupting the standard security configuration for most businesses that protects traffic between the internet and the LAN. One solution to this problem is using a larger gateway device having a larger processor and memory that is capable of supporting the additional VPN tunnels. However, it can be expensive to continually upgrade the gateway device in order to add capacity. Additionally, such a solution does not scale well when compared to a distributed configuration. Another solution is to use multiple independent smaller VPN devices to manage the added VPN tunnels. This solution is not viable since now you have to manage each of the separate devices. In addition, the tunnels have to be individually configured to each VPN device, instead of working with a single device configuration. Also, this solution does not provide the appearance of a single VPN Firewall Device from the outside and can lead to further management complexity. The system and method described herein provides an improvement over the conventional options of using a single large VPN concentrator or a number of independent smaller VPN concentrators. With the system and method provided herein, more capacity can be added by just installing another offload device and configuring some tunnels to be handled by it.

Additionally, in the past VPN gateways used to frequently reside on separate devices, completely independent from the firewalls that protected the LAN from the Internet. These VPN end-points acted independently of the gateway and generally could not be clustered to enable expansion of capacity.

To these ends, various measures have been implemented. In accordance with the present invention, a system and method for establishing virtual private network (VPN) connections that can accommodate additional IPsec tunnels using offload devices is provided. As a result, a system and method is provided using a single device that internally provides a single point of configuration for the firewall filters/rules and VPN configuration and externally appears as a single device for all the remote VPN clients trying to connect to a secure network, including those that were being added.

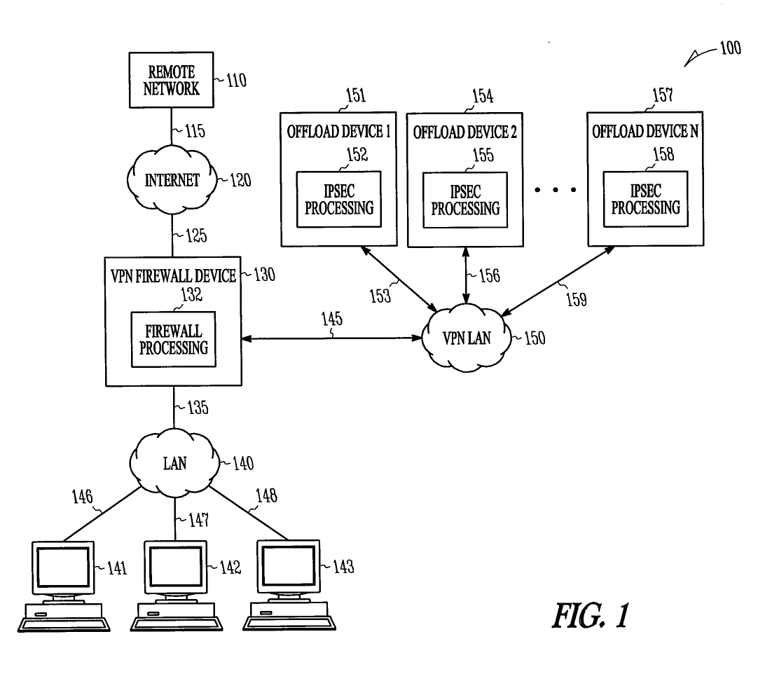

FIG. 1 illustrates a system 100 showing a firewall device that provides virtual private network (VPN) connections and accommodates additional IPsec tunnels using offload devices, according to some embodiments of the invention.

System 100 includes a VPN firewall device 130 coupled to VPN LAN 150 using a communication link 145. The VPN firewall device 130 includes a firewall processing module 132. In some embodiments, the firewall processing module 132 is also configured to perform IPsec processing. VPN LAN 150 is coupled to offload devices 151, 154 and 157 using communication links 153, 156 and 159, respectively. The offload devices 151, 154 and 157 are configured to include IPsec processing modules 152, 155 and 158, respectively. Additionally, FIG. 1 shows a remote network 110 coupled to the VPN firewall device 130 across the internet 120 using communication links 115 and 125. Servers (such as storage devices, computers etc) 141, 142 and 143 are coupled to the VPN firewall device 130 using LAN 140 and communication link 135. Communication links 115 and 125 may be provided by either a cable operator or any other internet service provider. Throughout this document, any of the communication links mentioned herein could be either wired or wireless.

VPN firewall device 130 is configured to operate as a firewall using the firewall processing module 132. The firewall allows for the control of both incoming and outgoing access so that PCs (such as 141, 142 and 143) on local networks can have tailored Internet access facilities while being shielded from malicious attacks from external networks. The firewall within VPN firewall device 130 keeps track of outgoing connections, such as a PC on LAN 140 requesting content from a server on the Internet 120, and only allows corresponding incoming traffic, such as the server on the Internet sending the requested content to the PC.

FIG. 1 provides for the offloading of tunnels from a VPN firewall device 130 to IPsec processing offload devices 151, 154 and 157 through the LAN connection. IPsec processing modules 152, 155 and 158 are configured to perform IPsec processing which includes processing IP packets to secure them as they traverse the network. Data processed by an application (e.g. HTTP, Telnet, FTP, SMTP, etc.) is divided into packet units for transmission over the network. Each of these packet units contains an IP header and data. The IP header functions as an electronic envelope, helping network components guide the data from source to destination. It includes addressing information for the sender and receiver, protocol identification, and sequencing numbers needed to resemble the data. IPsec processing modules 152, 155 and 158 encrypt portions of the packet and add additional header information (i.e. the IPsec header) to enable the recipient to authenticate the sender of encrypted packets. In some embodiments, IPsec processing modules 152, 155 and 158 are also capable of decrypting the encrypted packets. Typically, the IPsec header can take on a number of forms, depending on the services configured.

IPSec VPN offloading improves overall tunnel counts and throughput by configuring additional devices (can be similar to VPN firewall device 130) as offload devices. In some embodiments, IPSec offload devices 151, 154 and 157 can be just another firewall device (similar to VPN firewall device 130) that has been specifically configured to handle IPSec offloading. In some embodiments, a single firewall device 130 can be configured to manage about 400 IPSec tunnels. Using the offloading configuration shown in FIG. 1-3, the number of IPSec tunnels can be doubled, tripled, or even quadrupled by adding more offload devices. This does not require any additional IP addresses. In some embodiments, a single Internet IP address and one firewall device management console can administer all of the tunnels. In some embodiments, the offload device will handle the encryption and key processing required for all offloaded tunnels, thus greatly reducing the load on the main gateway device.

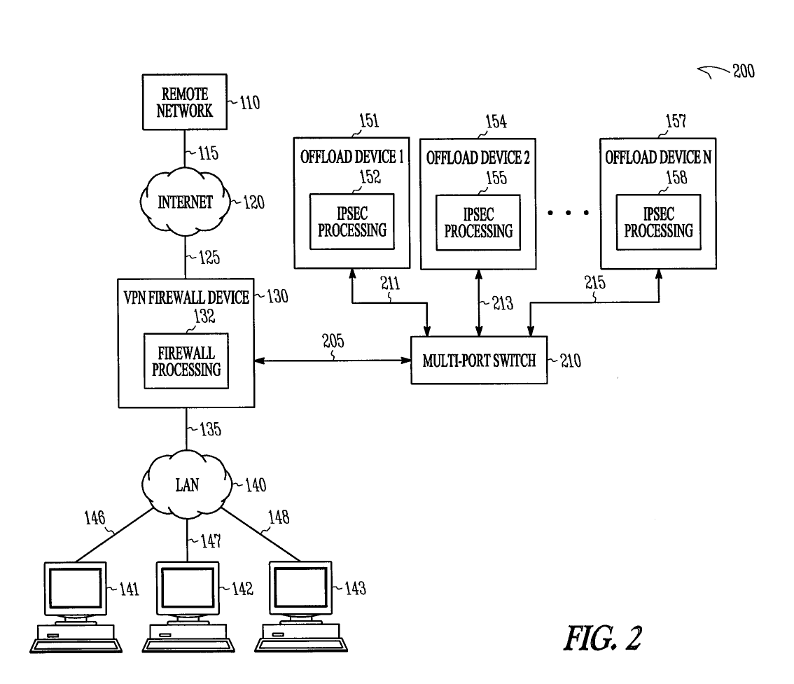

FIG. 2 illustrates a system 200 showing the firewall device in FIG. 1 coupled to the offload devices using a multi-port switch, according to some embodiments of the invention.

System 200 includes the VPN firewall device 130 coupled to multi-port switch 210 using a communication link 205. Multi-port switch 210 is coupled to offload devices 151, 154 and 157 using communication links 211, 213 and 215. As shown in FIG. 1, offload devices 151, 154 and 157 are configured to include IPsec processing modules 152, 155 and 158, respectively. Also, as in FIG. 1, VPN firewall device 130 includes a firewall processing module 132. FIG. 2 provides for the offloading of VPN tunnels from the VPN firewall device 130 to the IPsec processing offload devices 151, 154 and 157 using a multi-port switch 210.

Furthermore, the remote network 110 is coupled to the VPN firewall device 130 across the internet 120 using communication links 115 and 125. In addition, computers or servers 141, 142 and 143 are coupled to LAN 140 using communication links 146, 147 and 148, respectively and LAN 140 is coupled the VPN firewall device 130 using communication link 135. IPsec processing modules 152, 155 and 158 perform functions similar to that described for FIG. 1.

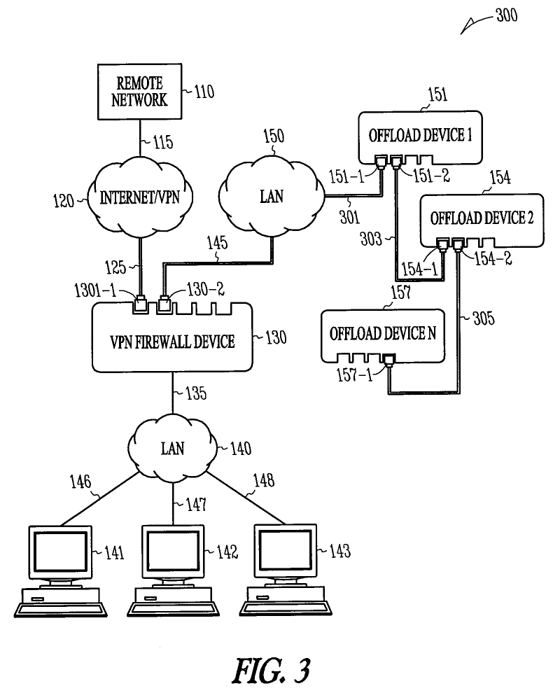

FIG. 3 illustrates a system 300 showing the firewall device in FIG. 1 coupled to the offload devices using a daisy-chain configuration, according to some embodiments of the invention. System 300 includes the VPN firewall device 130 coupled to LAN 150 using a communication link 145. Offload device 151 is coupled to LAN 150 using communication link 301. Offload device 154 is coupled to offload device 151 using communication link 303. Offload device 157 is coupled to offload device 154 using communication link 305. Similar to FIG. 1 and FIG. 2 the remote network 110 is coupled to the VPM firewall device 130 across the internet 120 using communication links 115 and 125. Additionally, computers or servers 141, 142 and 143 are coupled to LAN 140 using communication links 146, 147 and 148, respectively and LAN 140 is coupled to the firewall device 130 using communication link 135. IPsec processing modules 152, 155 and 158 perform functions similar to that described for FIG. 1. FIG. 3 illustrates a three daisy-chained configuration using offload devices 151, 154 and 157. Offload devices 151, 154 and 157 are connected via 4-port switches provided within the offload devices.

Offload devices 151, 154 and 157 can either be added to an existing switch on LAN 150, or live on their own dedicated LAN segment and switch. In some embodiments, if there are no sufficient switch ports available on switch 210, then it is possible to use the switch ports 151-1, 151-2 of offload device 151, switch ports 154-1, 154-2 of offload device 154 and switch port 157-1 of offload device 157 to chain offload devices together as they do not communicate with each other, and only require simple single-IP address visibility to the VPN firewall device 130. In some embodiments, the optimal arrangement for conserving switch ports is a tree layout. In some embodiments, the offload devices 151, 154 and 157 are capable of detecting and resolving any wiring loops (802.1d) should any be inadvertently created. In some embodiments, a four port switch is provided within offload devices 151, 154 and 157.

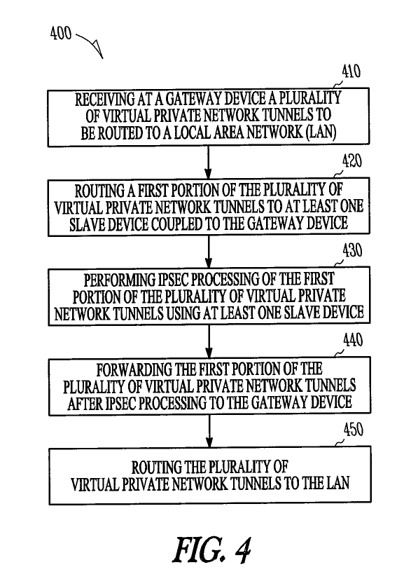

FIG. 4 illustrates a method 400 to add IPsec tunnels to a firewall device using offload devices, according to some embodiments of the invention. At 410, method 400 includes receiving at a gateway device a plurality of virtual private network tunnels to be routed to a Local Area Network (LAN). At 420, method 400 includes routing a first portion of the plurality of virtual private network tunnels to at least one slave device coupled to the gateway device. At 430, method 400 includes performing IPsec processing of the first portion of the plurality of virtual private network tunnels using at least one slave device. At 440, method 400 includes forwarding the first portion of the plurality of virtual private network tunnels after IPsec processing to at the gateway device. At 450, method 400 includes routing the plurality of virtual private network tunnels to the LAN.

In some embodiments, method 400 includes performing IPsec processing of the first portion of the plurality of virtual private network tunnels includes encrypting the first portion of the plurality of virtual private network tunnels. In some embodiments, performing IPsec processing includes performing key processing of the first portion of the plurality of virtual private network tunnels. In some embodiments, method 400 includes forwarding the first portion of the plurality of virtual private network tunnels using LAN. In some embodiments, method 400 includes forwarding the first portion of the plurality of virtual private network tunnels using an alternate LAN (not shown in the figure) other than LAN.

Methods provided herein allows for the transparent expandability of a corporate network. That is, the standard apparent packet flow from LAN to WAN via a single FW/VPN security device is not disrupted in any way. Using the method provided herein, the routing rules and firewall rules are not changed to provide for the addition of further IPsec/VPN tunnels. Additionally, the administration of the IPsec/VPN tunnels added onto an existing FW/VPN security device can be managed by one IPsec user interface. In some embodiments, the same kind of hardware device used for the master device can be used for the slave device.

By distributing the IPsecNVPN tunnel load across a configurable (and potentially large) number of commodity VPN devices the cost of managing the tunnels is greatly reduced. Each Offload device can comfortably maintain it's group of VPN tunnels and not experience any increased load at all as more tunnels are added to additional Offload devices. Because of the unique way in which the VPN Offload devices are networked to the “master” device, the appearance of a single internal/external device is preserved. Although there may be a substantial number of offload devices working to achieve the requirements, for an external customer it appears as though a single device is operating as the FW/VPN security device. Another advantage of such a system and method includes easier day-to-day management and thereby better fault tolerance because the VPN tunnels are spread across multiple independent devices. Furthermore, by spreading the VPN load across multiple devices the overall throughput can be increased substantially.

Moreover, in using the systems and method described herein, virtually none of the usual security policy and administrative activities that would be performed on the VPN firewall device 130 are disrupted in any way when additional VPN tunnels are being added. None of the remote endpoints require reconfiguration if it is decided they should no longer be processed on VPN firewall device 130 but rather moved to any of the offload devices 151, 154 and 157. In addition, only one public IP address is needed to potentially terminate thousands on IPsec tunnels on a relatively small number of VPN devices. Capacity can be increased just be adding offload devices to the existing configuration shown in FIGS. 1-3. Another advantage of such a setup is that it is not necessary to anticipate future growth well in advance in order to buy the right equipment. Additionally, the methods described herein provides for enhanced security due to the use of a single location (VPN firewall device 130) for executing firewall rules and filtering.

In some embodiments, traffic for VPN sessions that is to be offloaded is intercepted on the VPN firewall device 130 and forwarded via routing and network address translation (NAT) rules to any of offload devices 151, 154 and 157 for VPN processing using communication link 145, 205. Once en/de-capsulated it returns to VPN firewall device 130 over the same links 145, 205 and is now forwarded to its final destination, as if the entire VPN processing had been done on the VPN firewall device 130, itself. In some embodiments, the VPN tunnels that can only be offloaded to offload devices 151, 154 and 157 include tunnels using internet key exchange (IKE) and pre-shared key (PSK) that operate on the default gateway namely VPN firewall device 130.

In some embodiments, the configuration of offload device 151, 154 and 157 is automatic accomplished by simply nominating that a VPN tunnel should reside on a particular offload device 151, 154 or 157. In some embodiments, the logging and aliveness information regarding a particular tunnel is automatically forwarded to the VPN firewall device 130, via a preconfigured certificate based SSH link (or some other suitable automatable command-line interface connection), such that administrators rarely if ever need to directly access offload device 151, 154 or 157 for anything. There is no restriction to the number of offloaded devices that can be added to an existing configuration.

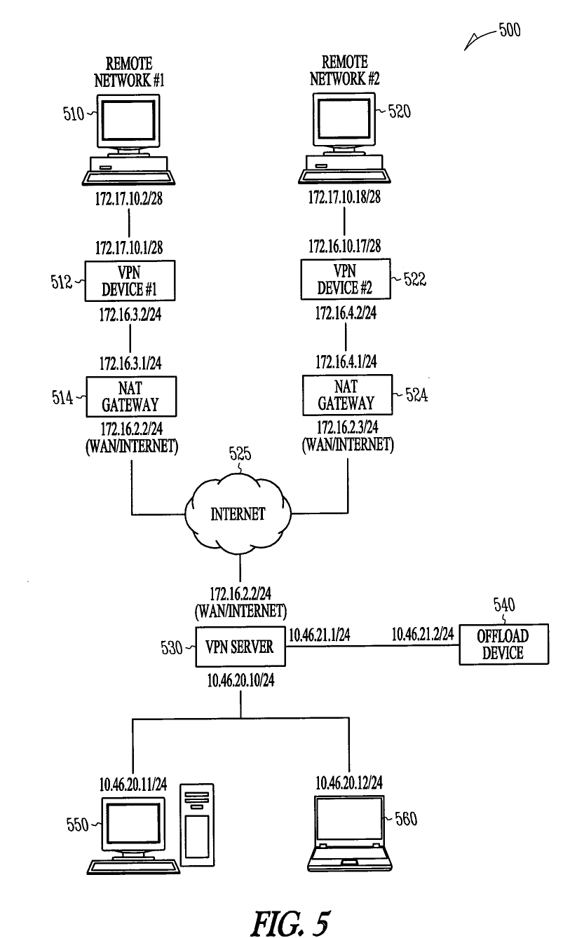

FIG. 5 illustrates a network diagram 500 showing a system and method for off-loading VPN tunnels from a master device (such as 530) onto a slave device (such as 540), according to some embodiments of the invention. FIG. 5 shows a network diagram 500 that includes remote networks 510 and 520, VPN devices 512 and 522, NAT gateways 514 and 524, internet 525, VPN server 530 (or VPN firewall device), offload device 540 and workstations 550 and 660. As shown in FIG. 5, remote network 510 is coupled to VPN device 512, which is coupled to NAT gateway 514. Similarly, remote network 520 is coupled to VPN device 522, which is coupled to NAT gateway 524. NAT gateways 514 and 524 are coupled to the internet to communicate with VPN server 530. In some embodiments, VPN server 530 may include one or more devices similar to VPN firewall device 130 shown in FIGS. 1-3. VPN server 530 is coupled to offload device 540 that provides for off-loading of VPN tunnels as described herein. In some embodiments, workstations 550 and 560 are coupled to VPN server 530 using a local area network (such as 140). The network diagram shown in FIG. 5 is configured to support a set of IPsec tunnels between VPN device 512 and VPN server 530. Similarly another set of IPsec tunnels may be configured between VPN device 522 and VPN server 530. These IPsec tunnels can be offloaded to offload device 540 for performing the processing (for example, processing cryptographic key exchanges, VPN management overheads) that normally is performed in VPN server 530. The arrangement shown in FIG. 5 allows for a larger number of IPsec tunnels to be supported by the VPN server 530 when it operates in conjunction with offload device 540. This arrangement also avoids any unnecessary upgrade of VPN server 530 to a larger VPN server capable of supporting IPsec tunnels over and above the capacity of VPN server 530.

The following steps may be repeated for each VPN tunnel to be moved off the VPN server 530 to offload device 540.

1. Choose a VPN tunnel where the remote end is identifiable, basically meaning it has a static IP address, or the upstream router for it has a fixed IP address (if it is NATed).

2. Add the following rules to the custom firewall rules. In one example, the IP address of remote NAT gateway 524 is 172.16.2.3, the IP address of the VPN offload device 540 is 10.46.21.2 and the network behind the remote IPSec endpoint is 172.17.10.16/28.

iptables-A PFWanPriv-i eth1-s 172.16.2.3-d 10.46.21.2-p udp—dport 500-j ACCEPT

iptables-A PFWanPriv-i eth1-s 172.16.2.3-d 10.46.21.2-p udp—dport 4500-j ACCEPT

iptables-A PFWanPriv-i eth1-s 172.16.2.3-d 10.46.21.2-p 50-j ACCEPT

iptables-t nat-A PREROUTING-i eth1-p udp-s 172.16.2.3-d 172.16.1.2—dport 500-j DNAT—to-destination 10.46.21.2

iptables-t nat-A PREROUTING-i eth1-p udp-s 172.16.2.3-d 172.16.1.2—dport 4500-j DNAT—to-destination 10.46.21.2

iptables-t nat-A PREROUTING-i eth1-p 50-s 172.16.2.3-d 172.16.1.2-j DNAT—to-destination 10.46.21.2

route add-net 172.17.10.16 netmask 255.255.255.240 gw 10.46.21.2

3. After these firewall rules are in place, add an IPsec tunnel to the VPN offload device 540 that is an exact copy of the tunnel on the VPN server 530.

4. Disable the tunnel on the VPN server 530 (however, do not remove it). The tunnel should now be operational on the VPN offload device 540 and the access control should still function as expected via the VPN server 530.

As discussed above, the VPN server 530 is configured in such a way to push the tunnel configuration to the appropriate VPN offload device 540. In some embodiments, the tunnels could be auto detected from the rules above by matching the routing information to the IPsec configuration.

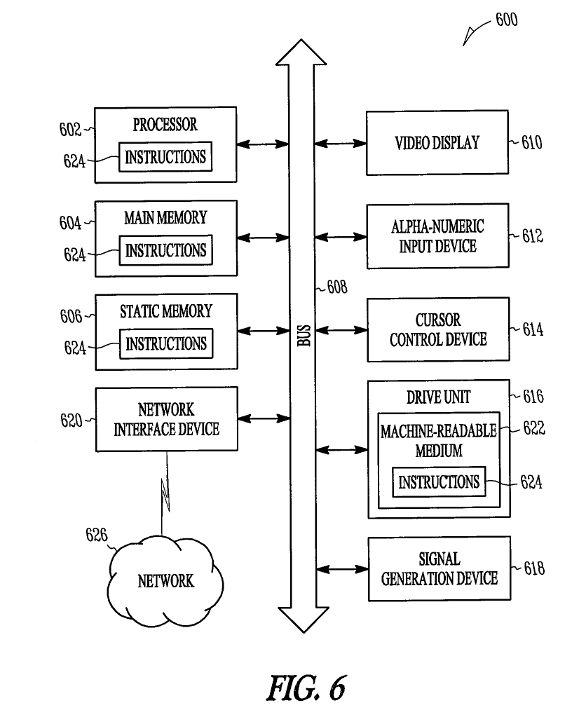

FIG. 6 is a block diagram illustrating a master device in the example form of a VPN server 600, within which a set of sequence of instructions for adding IPsec tunnels to a firewall device using offload devices, according to some embodiments of the invention.

In some embodiments, the VPN server 600 described herein may be coupled to a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions that specify actions to be taken by that machine. Further, while only a single machine is illustrated, the term “machine” shall also be taken to include any collection of machines that individually or jointly execute a set of instructions to perform any one or more of the methodologies discussed herein.

The VPN server 600 includes a processor 602 (e.g., a central processing unit (CPU) a graphics processing unit (GPU) or both), a main memory 604 and a static memory 606, which communicate with each other via a bus 608. The VPN server 600 may further include a video display unit 610 (e.g., a liquid crystal display (LCD) or a cathode ray tube (CRT)). The VPN server 600 also includes an alphanumeric input device 612 (e.g., a keyboard), a cursor control device 614 (e.g., a mouse), a disk drive unit 616, a signal generation device 618 (e.g., a speaker) and a network interface device 620. The disk drive unit 616 includes a computer-readable medium 622 on which is stored one or more sets of instructions (e.g., software 624) embodying any one or more of the methodologies or functions described herein. In some embodiments, the computer readable medium 622 is encoded with instructions, wherein the instructions when executed comprises configuring a gateway device (e.g. 530) to receive a plurality of virtual private network tunnels (e.g., the IPsec tunnels between VPN device 512 and VPN server 530 or the IPsec tunnels between VPN device 522 and VPN server 530) to be routed to workstations (e.g., 550, 560) on a Local Area Network (LAN). In some embodiments, the computer readable medium 622 is encoded with instructions wherein the instructions when executed includes routing a first portion of the plurality of virtual private network tunnels to at least one slave device (e.g. 540) coupled to the gateway device (e.g. 530).

In some embodiments, the computer readable medium 622 is encoded with instructions wherein the instructions when executed includes performing IPsec processing of the first portion of the plurality of virtual private network tunnels using at least one slave device (e.g. 540).

In some embodiments, the computer readable medium 622 is encoded with instructions wherein the instructions when executed includes forwarding the first portion of the plurality of virtual private network tunnels after IPsec processing to the gateway device (e.g. 530).

In some embodiments, the computer readable medium 622 is encoded with instructions wherein the instructions which when executed include routing of the plurality of virtual private network tunnels to the LAN (e.g 140).

The software 624 may also reside, completely or at least partially, within the main memory 604 and/or within the processor 602 during execution thereof by the master device 600, the main memory 604 and the processor 602 also constituting machine-readable media. The software 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media.

The above-described steps can be implemented using standard programming techniques. The novelty of the above-described embodiment lies not in the specific programming techniques but in the use of the methods described to achieve the described results. Software programming code which embodies the present application is typically stored in permanent storage. In a client/server environment, such software programming code may be stored in storage associated with a server. The software programming code may be embodied on any of a variety of known media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is intended that this invention be limited only by the claims and the equivalents thereof.

What is claimed is:

1. A system comprising:
a gateway device coupled to a LAN and configured to provide a plurality of Virtual Private Network (VPN) tunnels between the Local Area Network (LAN) and a public network;
at least one slave device coupled to the gateway device configured to perform IPsec processing of a first portion of the plurality of virtual private network tunnels and return the first portion of the plurality of virtual private network tunnels back to the gateway device for firewall processing; and
a plurality of devices coupled to the LAN and configured to communicate using at least one of the plurality of VPN tunnels.

2. The system of claim 1, wherein the gateway device is configured to operate as a firewall device between the LAN and the public network.

3. The system of claim 1, wherein the at least one slave device is configured to encrypt the first portion of the plurality of virtual private network tunnels.

4. The system of claim 1, wherein the at least one slave device is configured to perform key processing for a first portion of the plurality of virtual private network tunnels.

5. The system of claim 1, wherein a first slave device includes an n-port switch configured to communicate with a second slave device.

6. The system of claim 1, further comprising:
a multi-port switch to couple at least one slave device to the gateway device.

7. The system of claim 1, wherein at least one slave device is coupled to the gateway device using a Local Area Network (LAN).

8. The system of claim 1, wherein the slave devices are coupled to the gateway device in a daisy chain configuration.

9. A method comprising:
receiving at a gateway device a plurality of virtual private network tunnels to be routed to a Local Area Network (LAN);
routing a first portion of the plurality of virtual private network tunnels to at least one slave device coupled to the gateway device;
performing IPsec processing of the first portion of the plurality of virtual private network tunnels using at least one slave device;
forwarding the first portion of the plurality of virtual private network tunnels after IPsec processing to the gateway device; and
routing the plurality of virtual private network tunnels to the LAN.

10. The method of claim 9, wherein performing IPsec processing of the first portion of the plurality of virtual private network tunnels includes encrypting the first portion of the plurality of virtual private network tunnels.

11. The method of claim 9, wherein performing IPsec processing of the first portion of the plurality of virtual private network tunnels includes performing key processing of the first portion of the plurality of virtual private network tunnels.

12. The method of claim 9, wherein forwarding the first portion of the plurality of virtual private network tunnels includes forwarding the first portion of the plurality of virtual private network tunnels using the LAN.

13. The method of claim 9, wherein forwarding the first portion of the plurality of virtual private network tunnels includes forwarding the first portion of the plurality of virtual private network tunnels using a second LAN.

14. The method of claim 9, wherein receiving at a gateway device a plurality of virtual private network tunnels to be routed to a Local Area Network (LAN) includes receiving at a VPN server the plurality of virtual private network tunnels to be routed to the Local Area Network (LAN).

15. A computer readable medium encoded with instructions, wherein the instructions when executed comprising:
receiving at a gateway device a plurality of virtual private network tunnels to be routed to a Local Area Network (LAN);
routing a first portion of the plurality of virtual private network tunnels to at least one slave device coupled to the gateway device;
performing IPsec processing of the first portion of the plurality of virtual private network tunnels using at least one slave device;
forwarding the first portion of the plurality of virtual private network tunnels after IPsec processing to the gateway device; and
routing the plurality of virtual private network tunnels to the LAN.

16. The computer readable medium of claim 15, wherein performing IPsec processing of the first portion of the plurality of virtual private network tunnels includes encrypting the first portion of the plurality of virtual private network tunnels.

17. The computer readable medium of claim 15, wherein performing IPsec processing of the first portion of the plurality of virtual private network tunnels includes performing key processing of the first portion of the plurality of virtual private network tunnels.

18. The computer readable medium of claim 15, wherein forwarding the first portion of the plurality of virual private network tunnels includes forwarding the first portion of the plurality of virual private network tunnels using the LAN.

19. The computer readable medium of claim 15, wherein forwarding the first portion of the plurality of virtual private network tunnels includes forwarding the first portion of the plurality of virual private network tunnels using a second LAN.

20. The computer readable medium of claim 15, wherein receiving at a gateway device a plurality of virual private network tunnels to be routed to a Local Area Network (LAN) includes receiving at a VPN server the plurality of virtual private network tunnels to be routed to the Local Area Network (LAN).
